(19) United States
(12) Patent Application Publication
(10) Pub. No.: US 2020/0191611 A1
(43) Pub. Date: Jun. 18, 2020

(54) WHEEL ROTATION DETECTION COMPONENT AND ROBOTIC CLEANER

(71) Applicants: JIANGSU MIDEA CLEANING APPLIANCES CO., LTD., Suzhou (CN); MIDEA GROUP CO., LTD., Foshan (CN)

(72) Inventors: Wei HU, Suzhou (CN); Xianmin Wei, Suzhou (CN); Shiqing Xing, Suzhou (CN)

(21) Appl. No.: 16/705,074

(22) Filed: Dec. 5, 2019

(30) Foreign Application Priority Data
Dec. 13, 2018 (CN) 201811524250.X

(51) Int. Cl. G01D 5/25

(52) U.S. Cl. CPC G01D 5/25

(57) ABSTRACT

A wheel rotation detection component and a robotic cleaner thereof are provided and are suitable for wheel rotation detection. The wheel rotation detection component includes a support frame, a wheel, a magnet and detection elements for inducing a change of a magnetic field of the magnet to detect a rotation information of the wheel. The wheel is movably connected to the support frame, the magnet is fixed on the wheel, the wheel rotation detection component further includes a magnetic conduction shaft being magnetized by the magnet to conduct the magnetic field to the detection elements, one end of the magnetic conduction shaft is connected to the support frame, the other end of the magnetic conduction shaft is connected to the main body, and the detection elements are connected to the main body. The robotic cleaner includes a main body and the wheel rotation detection component.

### CROSS-REFERENCES TO RELATED APPLICATIONS

The present application is based on and claims priority to Chinese patent application number 201811524250.X, filed on Dec. 13, 2018, the entire disclosure of which is hereby incorporated by reference.

### FIELD

The disclosure belongs to the field of wheel rotation detection, and particularly relates to a wheel rotation detection component and a robotic cleaner thereof.

### BACKGROUND

When an existing robotic cleaner, such as a sweeper, works, it is difficult to judge whether a driving wheel set slips or not, which causes that only the driving wheel set rotates but the position of the sweeper is not changed. The slip of the driving wheel set has effects on the cleaning efficiency, coverage and map planning cleaning of the sweeper. In order to detect whether the sweeper is displaced or not, the most widely used detection scheme on the market is to detect the rotation of a universal wheel of the sweeper. Because the universal wheel has no rotation power, the universal wheel can be rotated only when the driving wheel set drives the entire sweeper to move. Therefore, it is possible to judge whether the sweeper has a position change or not by detecting the rotation condition of the universal wheel.

At present, two schemes for detecting the rotation of the universal wheel are generally provided: one scheme is that the rotation of the universal wheel is detected by infrared rays; and the other scheme is that a magnet is disposed on the universal wheel, and a Hall sensor is used for detecting the change of a magnetic field to judge whether the universal wheel rotates or not. The two detection schemes can detect the rotation condition of the universal wheel, but the universal wheel is assembled on a universal wheel support capable of rotating by 360°, and a detection element only can be assembled on a body far away from the universal wheel and may not be assembled on the universal wheel support capable of rotating because the detection element has connecting wires. Due to farther distance, the external interference is large; and due to shielding of the universal wheel support, the detection error is larger, and the detection accuracy is low. If the detection element is disposed on the universal wheel support capable of rotating by 360°, the distance between the detection element and the universal wheel is reduced and the external interference is reduced, but the processing of connecting wires between the detection element and the body also leads to an increase in cost, an increase in reliability difficulty and an increase in production difficulty. Therefore, at present, the problem of far distance detection between the detection element and the universal wheel is still not solved.

### SUMMARY

Based on the above, embodiments of the disclosure provide a wheel rotation detection component and a robotic cleaner thereof to solve the problem of far distance detection between a wheel and a detection element.

Embodiments of the disclosure may be implemented as follows: at least a part of a wheel rotation detection component is connected to a main body of a supported object, the wheel rotation detection component includes a support frame, a wheel, a magnet and detection elements for inducing a change of a magnetic field of the magnet to detect a rotation information of the wheel, the wheel is movably connected to the support frame, the magnet is fixed on the wheel, the wheel rotation detection component further includes a magnetic conduction shaft capable of being magnetized by the magnet to conduct the magnetic field to the detection elements, one end of the magnetic conduction shaft is connected to the support frame, the other end of the magnetic conduction shaft is connected to the main body, and the detection elements are connected to the main body.

In one embodiment, the magnetic conduction shaft includes a shaft body, a first connector for connecting the main body and a second connector for connecting the support frame, the first connector and the second connector are respectively connected to two ends of the shaft body, the first connector is provided with a first connecting structure for movably connecting with the main body, and the second connector is provided with second connecting structures for fixedly or movably connecting with the support frame.

In one embodiment, the main body includes a base and a connecting part disposed on the base, the connecting part is provided with a first connecting hole for connecting the magnetic conduction shaft, a wall of the first connecting hole is provided with a bulge, the first connecting structure includes a slot, and the bulge is positioned in the slot.

In one embodiment, the detection elements are disposed on the side wall or an end or a bottom of the connecting part.

In one embodiment, a plurality of detection elements are disposed and uniformly distributed.

In one embodiment, the support frame includes a frame body and a second connecting hole formed in the frame body and configured to connect the second connector, and the second connector is inserted in the second connecting hole.

In one embodiment, the second connecting structures include positioning rings and/or positioning grooves, a wall of the second connecting hole is correspondingly provided with limiting protrusions, the limiting protrusions abut against the positioning rings, or the limiting protrusions are clamped in the positioning grooves.

In one embodiment, a plurality of positioning rings or positioning grooves are provided, the positioning rings or the positioning grooves are disposed at intervals, and the number of limiting protrusions is the same as the number of the positioning rings or the positioning grooves.

In one embodiment, the wheel is provided with a mounting groove, and the magnet is fixed in the mounting groove.

The disclosure also provides a robotic cleaner, including a main body and further including the above wheel rotation detection component, and at least a part of the wheel rotation detection component is connected to the main body. The wheel rotation detection component and the robotic cleaner thereof provided by the disclosure have the advantages that the magnet in the wheel rotation detection component is disposed on the wheel, the detection elements are disposed on the main body, and the magnetic conduction shaft capable of being magnetized by the magnet to conduct the magnetic field is adopted, so that by virtue of the connection of the magnetic conduction shaft, movable connection between the support frame and the main body is achieved; furthermore, the magnetic field of the magnet is conducted to the detection elements through the magnetic conduction shaft, so that real-time detection on the rotation condition of the wheel is achieved, the accuracy of the detection result is high, and the problems of larger detection error and low detection accuracy caused by far distance between the magnet and a detection element are overcome; and by virtue of the arrangement of the wheel rotation detection component, under the conditions that parts are not additionally provided and additional cost and design, production and manufacturing difficulty are not increased, the problem of far distance detection between the detection elements and the wheel is effectively solved.

### BRIEF DESCRIPTION OF THE DRAWINGS

Embodiments of the present disclosure will be described in the drawings:

FIG. 1 is a schematic view of a wheel rotation detection component provided by an embodiment of the disclosure, and detection elements are omitted.

FIG. 2 is a schematic view of a robotic cleaner provided by an embodiment of the disclosure.

FIG. 3 is a partially exploded view of a robotic cleaner provided by an embodiment of the disclosure.

FIG. 4 is a partially cross-sectional schematic view of a robotic cleaner provided by an embodiment of the disclosure.

FIG. 5 is a partially enlarged view of a part A in FIG. 4.

### LIST OF REFERENCE NUMERALS

11. support frame; 111. frame body; 112. second connecting hole; 113. limiting protrusion; 12. wheel; 121. mounting groove; 122. rotating shaft; 13. magnet; 14. detection element; 15. magnetic conduction shaft; 151. shaft body; 152. first connector; 1521. first connecting structure; 153. second connector; 1531. second connecting structure; 21. main body; 211. base; 212. connecting part; 213. first connecting hole; 214. bulge.

### DETAILED DESCRIPTION OF THE DISCLOSURE

Embodiments of the disclosure will be further described in detail below with reference to the drawings. It should be understood that the specific embodiments described herein are merely intended to illustrate the disclosure and are not intended to limit the disclosure.

At least a part of a wheel rotation detection component provided by an embodiment of the disclosure is connected to a main body 21 of a supported object. The supported object refers to an object characterized in that the movement of the overall position of the object needs to be achieved by mounting a wheel and the movement condition of the overall position needs to be detected, such as a sweeper and an explosive disposal robot. Therefore, whether the actual movement of the effective position of the entire sweeper occurs or not is obtained by detecting the rotation condition of the wheel, to be favorable for obtaining an actual working state and ensuring that the corresponding work may be performed reliably. In the embodiments of the disclosure, the wheel rotation detection component is applied to the sweeper for illustration, and herein, the application range of the wheel rotation detection component is not limited.

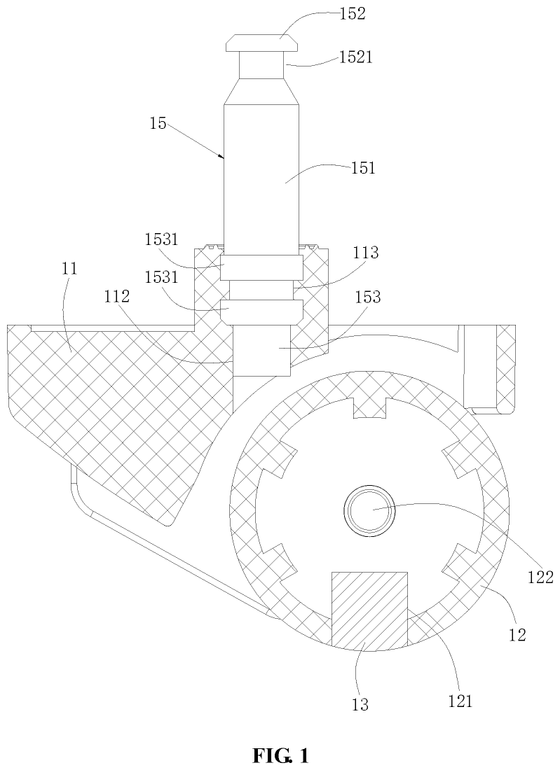

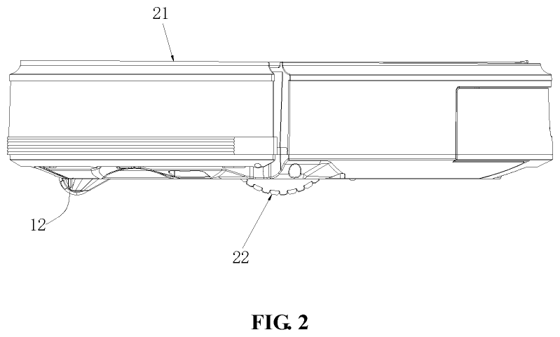

In one embodiment, as shown in FIG. 1 and FIG. 2, in the embodiments of the disclosure, the wheel rotation detection component includes a support frame 11, a wheel 12, a magnet 13 and detection elements 14 for inducing a change of a magnetic field of the magnet 13 to detect the rotation information of the wheel 12. The wheel 12 is movably connected to the support frame 11 and may flexibly rotate relative to the support frame 11. The magnet 13 is fixed on the wheel 12 and may rotate together with the wheel 12 when the wheel 12 rotates. The wheel rotation detection component further includes a magnetic conduction shaft 15 capable of being magnetized by the magnet 13 to conduct the magnetic field to the detection elements 14, one end of the magnetic conduction shaft 15 is connected to the support frame 11, the other end of the magnetic conduction shaft 15 is connected to the main body 21, and the detection elements 14 are connected to the main body 21. By virtue of such an arrangement, because the magnetic conduction shaft 15 is movably connected to the main body 21 and may rotate relative to the main body 21 by 360°, under the connection of the magnetic conduction shaft 15, the support frame 11 may rotate around the magnetic conduction shaft 15 as a rotating center to drive the wheel 12 to rotate to achieve direction adjustment during position movement. The principle of inducing the magnetic field of the magnet 13 by the detection elements 14 to detect the rotation condition of the wheel 12 is as follows: when the magnet 13 is close to the detection elements 14, a magnetic field is generated around the detection elements 14; when the detection elements 14 induce the change of the magnetic field, converted electric signals of different strength are transferred to a control module. When the magnet rotates to a position away from the detection elements 14, the strength of the magnetic field around the detection elements 14 is reduced; and the electric signals converted by the detection elements 14 are also weakened, and the control module judges whether the wheel 12 rotates or not by analyzing the change of the strength of the magnetic field induced by the detection elements 14, to determine whether the sweeper changes the position thereof or not. Thus, by adopting the arrangement mode that the magnet 13 is disposed on the wheel 12, the detection elements 14 are disposed on the main body 21 and the support frame 11 and the main body 21 are connected by the magnetic conduction shaft 15 capable of being magnetized and capable of conducting the magnetic field, the structural design of the components of the existing wheel 12 is not changed, and the detection elements 14 are still fixed on the main body 21 and have a farther distance from the magnet 13 on the wheel 12. However, the positions of the magnetic conduction shaft 15 and the detection elements 14 and the position at which the magnetic conduction shaft 15 may be magnetized by the magnet 13 are not changed. By conducting the magnetic field through the magnetic conduction shaft 15, even if the support frame 11 continuously rotates and even shields the magnet 13, the detection elements 14 may still accurately induce the change condition of the magnetic field caused by the rotation of the magnet 13 driven by the wheel in real time, to accurately and reliably detect the rotation condition of the wheel 12. By virtue of this solution, under the conditions that parts are not additionally provided and additional cost and design, production and manufacturing difficulty are not increased, the problem of far distance detection between the detection elements 14 and the wheel 12 is effectively solved, and the detection objective of accurately detecting whether the wheel 12 actually rotates or not is achieved.

On the sweeper, the rotation of the wheel 12 is driven by other driving wheel sets. When the wheel 12 rotates, it can be known that the overall position is moved. Thus, by virtue of the arrangement of the above wheel rotation detection component, the rotation condition of the wheel 12 may be accurately and reliably detected to detect whether the sweeping position of the sweeper is actually moved or not and improve the cleaning efficiency.

In one embodiment, the magnetic conduction shaft 15 is made of a material capable of being magnetized and capable of conducting the magnetic field, such as iron or steel, simultaneously has high support strength and may reliably support the main body 21.

In one embodiment, as shown in FIG. 1, the magnetic conduction shaft 15 includes a shaft body 151, a first connector 152 for connecting the main body 21 and a second connector 153 for connecting the support frame 11, the first connector 152 and the second connector 153 are respectively connected to two ends of the shaft body 151. The first connector 152 is provided with a first connecting structure 1521 for achieving movable connection with the main body 21, and the second connector 153 is provided with second connecting structures 1531 for achieving fixed or movable connection with the support frame 11. Thus, during connection, the first connector 152 is inserted in the main body 21, and under the connection action of the first connecting structure 1521, the magnetic conduction shaft 15 does not fall from the main body 21 but may rotate relative to the main body 21 to achieve adjustment on the running direction of the wheel 12. By inserting the second connector 153 in the support frame 11, under the connection action of the second connecting structures 1531, fixed connection or movable connection between the magnetic conduction shaft 15 and the support frame 11 is achieved. During specific connection, the first connector 152 and the main body 21 may be movably connected or fixedly connected. When the first connector 152 and the main body 21 are fixedly connected, the second connector 153 and the support frame 11 need to be movably connected, to ensure that the wheel 12 may rotate along a circumferential direction to achieve direction adjustment.

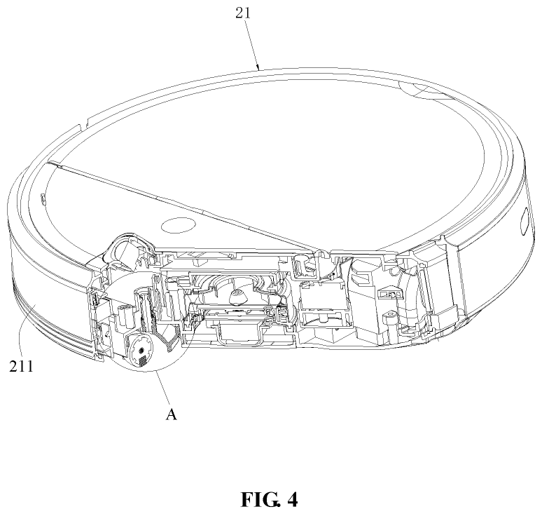

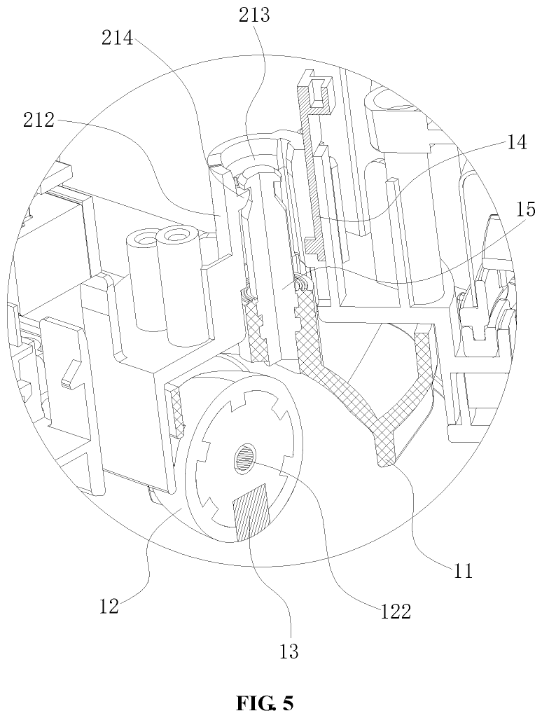

In one embodiment, as shown in FIG. 4 and FIG. 5, in the embodiments of the disclosure, the main body 21 includes a base 211 and a connecting part 212 disposed on the base 211, the connecting part 212 is provided with a first connecting hole 213 for connecting the magnetic conduction shaft 15, a wall of the first connecting hole 213 is provided with a bulge 214, and the first connecting structure 1521 includes a slot. When the first connector 152 is inserted in the first connecting hole 213, the bulge 214 is positioned in the slot to achieve movable connection between the magnetic conduction shaft 15 and the main body 21. The bulge 214 and the slot cooperate to limit the position of connection between the entire magnetic conduction shaft 15 and the main body 21, so that the magnetic conduction shaft 15 does not fall from the first connecting hole 213.

In order to ensure that buckles are clamped into the slot during connection, one side of the bulge 214 relative to the insertion direction of the first connector 152 may be provided with an inclined surface or a cambered surface, the top of the first connector 152 is provided with an inclined surface or a cambered surface, or the top of the first connector 152 is configured to be hemispherical, to guide the insertion of the first connector 152 and improving the convenience during assembly connection. Simultaneously, the side wall of the slot, in contact with the inclined surface or the cambered surface on the bulge 214, may also be configured to be an inclined surface or a cambered surface.

In actual arrangement, because the bulge 214 and the slot cooperate and are movably connected, the arrangement width of the slot in an axial direction is greater than the thickness of the bulge 214 to ensure that the magnetic conduction shaft 15 may reliably and flexibly rotate relative to the connecting part 212. At least two buckles are symmetrically disposed to ensure the firmness and reliability of connection.

In one embodiment, in order to improve the flexibility of the rotation of the magnetic conduction shaft 15 relative to the connecting part 212, the wall of the first connecting hole 213 or the magnetic conduction shaft 15 may be provided with a shaft sleeve, and the friction force on the magnetic conduction shaft 15 during rotation is reduced by the shaft sleeve, so that the magnetic conduction shaft 15 may flexibly rotate. Furthermore, the shaft sleeve may be made of a material capable of being magnetized and capable of conducting a magnetic field, to achieve the effect of improving the sensitivity of the detection elements 14 to induce the magnetic field.

In one embodiment, according to different design modes, on the premise that the change of the magnetic field on the magnetic conduction shaft 15 may be reliably induced, the detection elements 14 may be disposed on the side wall or an end or a bottom of the connecting part 212. In the embodiments of the disclosure, as shown in FIG. 5, the detection elements 14 are embedded on the side wall of the connecting part 212.

In one embodiment, in order to improve the sensitivity of detection, a plurality of detection elements 14 are disposed and uniformly distributed. The detection elements 14 may be disposed on the side wall, the end and the bottom of the connecting part 212. A plurality of detection elements 14 may be uniformly distributed on the side wall of the connecting part 212, or a plurality of detection elements 14 may be uniformly distributed on the end of the connecting part 212, or a plurality of detection elements 14 may be uniformly distributed on the bottom of the connecting part 212. The arrangement modes are flexible and diverse. The change of the magnetic field on the magnetic conduction shaft 15 is detected by a plurality of detection elements 14 together, to ensure the accuracy of detection.

In one embodiment, the detection elements 14 are sensor elements capable of detecting the change of the magnetic field (such as the change of the direction of the magnetic field or the change of magnetic flux), such as a Hall sensor or a geomagnetic sensor.

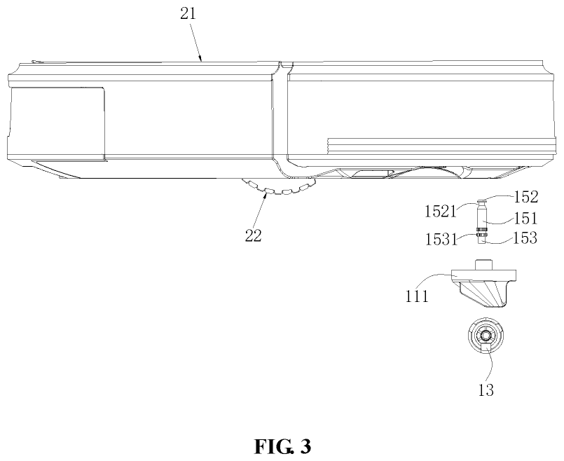

In one embodiment, as shown in FIG. 1 and FIG. 3, in the embodiments of the disclosure, the support frame 11 includes a frame body 111 and a second connecting hole 112 formed in the frame body 111 and configured to connect the second connector 153, and the second connector 153 is inserted in the second connecting hole 112. The depth at which the second connector 153 is inserted in the second connecting hole 112 may be the maximum proximity to the wheel 12 on the premise that the rotation of the wheel 12 is not affected, to improve the efficiency of magnetization by the magnet 13, and effectively conducting the magnetic field of the magnet 13. In specific connection, when the second connector 153 and the frame body 111 are movably connected, the second connector 153 and the second connecting hole 112 are in clearance fit, and under the limiting action of the second connecting structures 1531, it is possible to ensure that the second connector 153 and the frame body 111 are not separated from each other. When the second connector 153 and the frame body 111 are fixedly connected, the second connector 153 and the second connecting hole 112 are in interference fit, and under the limiting action of the second connecting structures 1531, it is possible to ensure the firmness and stability of connection between the second connector 153 and the frame body 111. When the second connector 153 and the frame body 111 are movably connected, in combination with movable connection between the first connector 152 and the connecting part 212, the rotation of the wheel 12 may be reliably achieved to achieve adjustment on the movement direction.

In one embodiment, the second connecting structures 1531 include positioning rings and/or positioning grooves, a wall of the second connecting hole 112 is correspondingly provided with limiting protrusions 113, the limiting protrusions 113 abut against the positioning rings, or the limiting protrusions 113 are clamped in the positioning grooves. By virtue of the corresponding cooperation between the limiting protrusions 113 and the positioning rings and/or the positioning grooves, reliable connection between the second connector 153 and the frame body 111 is achieved.

In one embodiment, in the embodiments of the disclosure, the connection mode between the second connector 153 and the frame body 111 is set to be fixed connection. Furthermore, a plurality of positioning rings or positioning grooves are provided, the positioning rings or the positioning grooves are disposed at intervals, and the number of limiting protrusions 113 is the same as the number of the positioning rings or the positioning grooves. Thus, by virtue of the corresponding cooperation between the plurality of limiting protrusions 113 and the positioning rings and/or the positioning grooves, the firmness of connection between the second connector 153 and the frame body 111 is ensured. Simultaneously, in order to further improve the firmness of connection, a plurality of grooves may be disposed on the positioning rings or in the positioning grooves and are configured to increase contact area with the wall of the second connecting hole 112, to improve the firmness of connection.

In one embodiment, as shown in FIG. 1 and FIG. 5, a rotating shaft 122 may be penetrated through the center of a circle of the wheel 12, and two ends of the rotating shaft 122 are correspondingly connected to the frame body 111 to achieve movable connection between the wheel 12 and the frame body 111. Of course, a rotating shaft 122 may be respectively disposed at the center of a circle of each of two sides of the wheel 12, and the rotating shaft 122 does not penetrate through the center of the circle, to also achieve movable connection between the wheel 12 and the frame body 111.

In one embodiment, in order to fix the magnet 13 on the wheel 12 to enable the magnet 13 to rotate together with the wheel 12, the wheel 12 is provided with a mounting groove 121, and then, the magnet 13 is fixed in the mounting groove 121 to achieve fixed mounting of the magnet 13. The magnet 13 and the mounting groove 121 may be connected in an interference fit, or the magnet may be fixed in the mounting groove 121 by means of gluing or embedding.

The wheel rotation detection component provided in the embodiments of the disclosure adopts the magnetic conduction shaft 15 capable of being magnetized by the magnet 13 to conduct the magnetic field, so that by virtue of the connection of the magnetic conduction shaft 15, movable connection between the support frame 11 and the main body 21 may be met; furthermore, the magnetic field of the magnet 13 is conducted to the detection elements 14 through the magnetic conduction shaft 15, so that real-time detection on the rotation condition of the wheel 12 is achieved, and the problems of larger detection error and low detection accuracy caused by far distance between the magnet 13 and a detection element 14 are overcome; and by virtue of the arrangement of the wheel rotation detection component, the accuracy of the detection result is high, under the conditions that parts are not additionally provided and additional cost and design, production and manufacturing difficulty are not increased, the problem of far distance detection between the detection elements 14 and the wheel 12 is effectively solved, and the design is ingenious.

The embodiments of the disclosure also provide a robotic cleaner. As shown in FIG. 2 to FIG. 3, the robotic cleaner includes a main body 21 and further includes the above wheel rotation detection component, and at least a part of the wheel rotation detection component is connected to the main body 21. The robotic cleaner further includes a driving wheel set 22 for driving the overall robotic cleaner to move. By virtue of the arrangement of the above wheel rotation detection component, whether the wheel 12 on the bottom of the main body 21 rotates or not may be reliably and accurately detected to judge whether the robotic cleaner actually moves or not, to avoid the use problem caused by the fact that the robotic cleaner does not move due to slip of driving wheels. Whether the main body 21 moves or not is detected by the wheel rotation detection component, so that when the slip occurs, the cleaning path may be adjusted in time, the cleaning efficiency and the cleaning coverage are ensured, and the reliability of automatic cleaning is improved.

1. A wheel rotation detection component, comprising:
at least a part of which is connected to a main body of a supported object, wherein the wheel rotation detection component comprises a support frame, a wheel, a magnet and detection elements for inducing a change of a magnetic field of the magnet to detect a rotation information of the wheel, the wheel is movably connected to the support frame, the magnet is fixed on the wheel, the wheel rotation detection component further comprises a magnetic conduction shaft configured to be magnetized by the magnet to conduct the magnetic field to the detection elements, a first end of the magnetic conduction shaft is connected to the support frame, a second end of the magnetic conduction shaft is connected to the main body, and the detection elements are connected to the main body.

2. The wheel rotation detection component of claim 1, wherein the magnetic conduction shaft comprises a shaft body, a first connector for connecting the main body and a second connector for connecting the support frame, the first connector and the second connector are respectively connected to a first and second end of the shaft body, the first connector is provided with a first connecting structure for movably connecting with the main body, and the second connector is provided with second connecting structures for fixedly or movably connecting with the support frame.

3. The wheel rotation detection component of claim 2, wherein the main body comprises a base and a connecting part disposed on the base, the connecting part is provided with a first connecting hole for connecting the magnetic conduction shaft, a wall of the first connecting hole is provided with a bulge, the first connecting structure comprises a slot, and the bulge is positioned in the slot.

4. The wheel rotation detection component of claim 3, wherein the detection elements are disposed on a side wall or an end or a bottom of the connecting part.

5. The wheel rotation detection component of claim 4, wherein a plurality of detection elements are disposed and uniformly distributed.

6. The wheel rotation detection component of claim 2, wherein the support frame comprises a frame body and a second connecting hole formed in the frame body and configured to connect the second connector, and the second connector is inserted in the second connecting hole.

7. The wheel rotation detection component of claim 6, wherein the second connecting structures comprise positioning rings and positioning grooves, a wall of the second connecting hole is correspondingly provided with limiting protrusions, the limiting protrusions abut against the positioning rings, or the limiting protrusions are clamped in the positioning grooves.

8. The wheel rotation detection component of claim 7, wherein a plurality of positioning rings or positioning grooves are provided, the positioning rings or the positioning grooves are disposed at intervals, and a number of limiting protrusions is equal to a number of the positioning rings or the positioning grooves.

9. The wheel rotation detection component of claim 1, wherein the wheel is provided with a mounting groove, and the magnet is fixed in the mounting groove.

10. A robotic cleaner, comprising:
a main body of a support object; and
a wheel rotation detection component, at least a part of which is connected to the main body of the supported object, wherein the wheel rotation detection component comprises:
a support frame, a wheel, a magnet and detection elements for inducing a change of a magnetic field of the magnet to detect a rotation information of the wheel, the wheel is movably connected to the support frame, the magnet is fixed on the wheel, the wheel rotation detection component further comprises:
a magnetic conduction shaft configured to be magnetized by the magnet to conduct the magnetic field to the detection elements, a first end of the magnetic conduction shaft is connected to the support frame, a second end of the magnetic conduction shaft is connected to the main body, and the detection elements are connected to the main body, wherein at least a part of the wheel rotation detection component is connected to the main body.
